(19) United States
(12) Patent Application Publication
(10) Pub. No.: US 2017/0252896 A1
(43) Pub. Date: Sep. 7, 2017

(54) METHOD FOR TREATING A COMPOSITE PART

(71) Applicant: EUROPE TECHNOLOGIES, Carquefou (FR)

(72) Inventors: Patrick GASCHER, La Montagne (FR); Eric MANGEARD, Mouzeil (FR); Vincent DESFONTAINE, Les Sorinieres (FR)

(73) Assignee: EUROPE TECHNOLOGIES, Carquefou (FR)

(21) Appl. No.: 15/512,215

(22) PCT Filed: Sep. 15, 2015
(86) PCT No.: PCT/EP2015/071092

§ 371 Date: Mar. 17, 2017

(30) Foreign Application Priority Data
Sep. 17, 2014 (FR) 1458776

(51) Int. Cl. B24C 1/10; F01D 9/02; B23P 15/02; F01D 5/28

(52) U.S. Cl. CPC B24C 1/10; F01D 5/282; F01D 9/02; F01D 5/286; B23P 15/02; F05D 2230/90; F05D 2300/171; F05D 2300/173; F05D 2300/6033

(57) ABSTRACT

A method for treating a composite part including a metal protective duct fixed to a core by a binder, so as to be able to separate the duct from the core, including the steps of: subjecting the metal duct to compressive stresses tending to lengthen same, and b) if necessary, heating or cooling the part in order to soften or weaken the binder.

The present invention relates to processes for treating composite parts and more particularly those comprising a protective metal shield fastened to a support core with the aid of a binder. The invention relates in particular to the separation of a metal element added to a composite part.

Many composite parts, for example made of carbon fibers, are surface-coated with a metal shield, in particular made of titanium, which aims to protect them against abrasion phenomena and increase their resilience. Thus, it is known to produce turbine blades or vanes with a monolithic or sandwich composite core, onto which a titanium shield is adhesively bonded in order to serve as surface and/or structural reinforcement. Patents EP 1 908 919 B1 and EP 0 854 208 B1 disclose examples of such parts.

During the use of the turbomachine, the metal shield is capable of wearing away or receiving impacts that may damage it.

Repairing the part comes up against the difficulty of removing the metal shield without degrading the composite core, since the adhesive used is particularly strong.

EP 0 854 208 B1 proposes to remove the metal shield by electroerosion, which involves the use of chemicals, with the corresponding environmental and usage constraints.

Patent application FR 2 970 197 relates to a process for disconnecting/connecting, by induction, a ferromagnetic mechanical part adhered to a mechanical part. This process requires ferromagnetic properties of the part to be treated. Furthermore, the proposed process involves a substantial temperature rise in order to obtain a significant elongation of the ferromagnetic mechanical part, which may damage the composite portion.

The invention aims to resolve this problem of separation of the metal shield and the core without damaging the core, so as to make it possible to reuse it with a new metal shield.

The invention achieves this by means of a process for treating a composite part comprising a metal shield attached to a core with the aid of a binder, with a view to separating the shield from the core, comprising the steps consisting in:

a) subjecting the metal shield to compressive stresses that tend to elongate it,

b) if necessary, heating the part or cooling it in order to soften or embrittle the binder.

The process may comprise a step (c) of separating the shield and the core.

The invention makes it possible, owing to the tendency of the shield to elongate in response to the introduction of the compressive stresses, to subject the binder and/or the interface thereof with the core or the shield to shear or tear stresses to facilitate the detachment of the shield from the core and thus to avoid exposing the core, during the removal of the shield, to actions capable of deteriorating it.

The invention makes it possible to repair numerous parts used in particular in aeronautics, which to date were replaced completely, owing to the difficulty encountered in separating the shield from the core without deteriorating the latter or excessive operating costs, linked to the use of chemicals.

Step a) is preferably carried out before step b). As a variant, step b) is carried out before step a). As a further variant, steps a) and b) take place simultaneously.

Where appropriate, step a) is applied exclusively, when the introduction of the compressive stresses is sufficient to free the shield, in particular in the case of a thin binder thickness and/or of a binder that is not very strong. in this case, the shear stress generated by the elongation of the metal portion is greater than the limit permissible by the binder, in particular at the interface with the core or the shield.

Step a) is advantageously carried out so as to generate a plastic deformation of the metalshield, and induce residual stresses therein.

Preferably, the steps a) then b) are carried out when the part is heated. This makes it possible to heat to the temperature necessary for a given introduced stress level, which makes it possible to optimize the heating parameters and the parameters linked to the introduction of stresses.

In particular in the case where the part is cooled, it is possible to carry out step b) before step a). The cold brings about a curing of the binder and therefore an increase of the shear stresses. Preferably, in this case, the operations a) and b) are very close together in time, leaving no time for the part to heat up overly between them.

The introduction of the compressive stresses in step a) may be carried out mechanically or by shock wave.

The introduction of the compressive stresses may in particular be carried out by conventional or ultrasonic shot peening, straightening, hammering, roller burnishing, flap peening, laser shock peening, cavitation peening and/or autofrettage.

Preferably, the introduction of the compressive stresses is carried out by shot peening or hammering, better still by ultrasonic shot peening or hammering, the shot peening preferably being carried out with the aid of a captive projectile machine.

The ALMEN intensity of the treatment generating the compressive stresses is preferably at least F10N to F70C, better still F30N to F10C.

The introduction of the compressive stresses may be carried out locally with the aid of a machine moved over the part or a movement of the part relative to the machine, which may then be static.

The supply of heat or cold in step b) may be carried out by conduction and/or convection and/or radiation.

The supply of heat or cold may be carried out by placing the part in a furnace or an oven or in a refrigerated chamber.

The supply of heat or cold may also be carried out locally with the aid of a machine moved over the part, or with the part being moved under the application means of the process. It is possible to have a source of heat or cold coupled with the tool used to apply the compressive stresses, in particular a straightening tool.

The supply of heat or cold may be carried out so as to bring, locally at least, the binder to a temperature between −273.15° C. and 450° C.

The metal shield may be machined before the introduction of the compressive stresses, preferably in order to remove a frontal portion thereof, in particular when it defines a relatively straight leading edge of the part.

The part may be a blade or a vane of a turbomachine and the shield may define the leading edge of this blade or vane.

The shield may be, after debonding from the core, replaced by a new metal shield adhesively bonded to the core.

The invention will be better understood on reading the detailed description that follows, the nonlimiting implementation examples thereof, and on examining the appended drawing, in which:

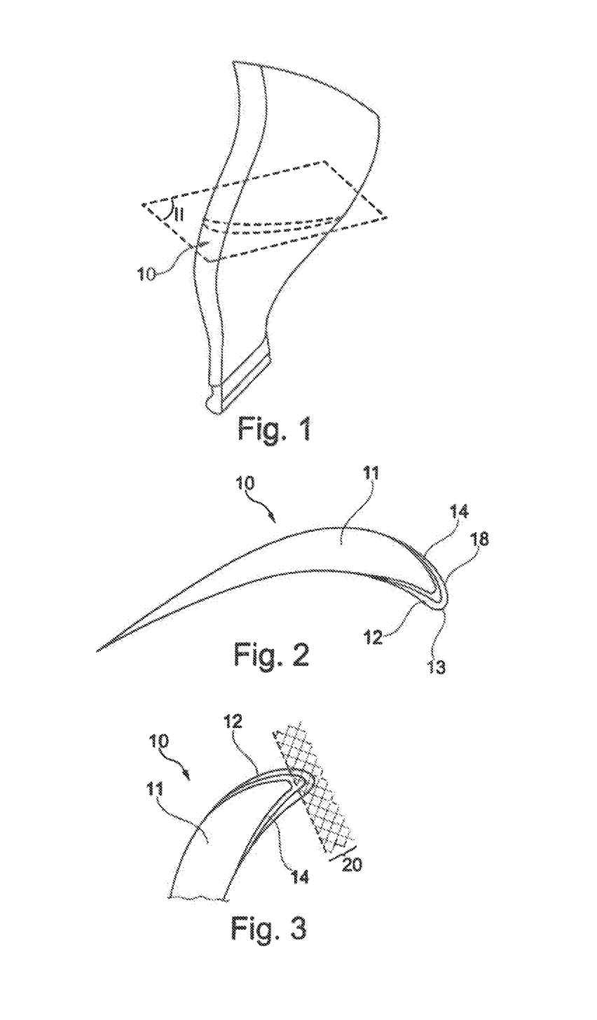

FIG. 1 represents, in perspective, an example of a composite part that may be treated with the process according to the invention in order to debond the shield from the core,

FIG. 2 is a cross section of the part from FIG. 1, in plan II of FIG. 1, and

FIG. 3 illustrates the portion of the shield to be removed by prior machining, in one implementation example.

The part 10 represented in FIGS. 1 and 2 is a turbomachine fan rotor blade. The blade 10 comprises a composite core 11, being obtained for example by drape-forming or weaving of a thermoplastic or thermosetting composite material. The latter may be an assembly of carbon fibers woven and molded by an RTM (Resin Transfer Molding) vacuum injection process. The core 11 is produced with an aerodynamic shape and it is covered on its leading edge by a metal skin 12 forming a shield, which is fastened by a binder 14 to the core. The skin 12 defines, by its frontal portion, the leading edge 13 of the part 10.

The invention consists in elongating the metal shield by the implementation of a compression technique consisting in the introduction of compressive stresses from the outer face 18 of the shield.

### Introduction of the Compressive Stresses

Many techniques may be used to introduce these compressive stresses.

It may be preferred to use a technique that enables local treatment of the part, without having to dismantle this part from the rest of the machine.

A technique that enables a treatment over the whole of the shield by moving, for example, a treatment device along this shield may also be favored.

A first technique that may be used to introduce the compressive stresses is conventional shot peening.

This technique consists in projecting onto the shield projectiles that may be varied, for example beads or cut wires, the size of which may range from 0.3 mm to 10 mm, and preferably from 1 mm to 4 mm, the projectiles being made of metals, ceramic, glass or composite materials, and preferably made of steel or ceramic.

The projectiles may be projected onto the surface to be treated with an angle of incidence relative to the normal which ranges from 0° to 90°, and preferentially from 0° to 45°.

The ALMEN intensity of the treatments may attain F10N to F70C, and preferentially F30N to F10C.

Another technique that may be used to introduce the compressive stresses is ultrasonic shot peening, as disclosed for example in WO 2008/047048.

The projectiles may be the same as in the case of conventional shot peening, and may for example be formed of beads, cut wires, etc., their size preferably ranging from 0.3 mm to 10 mm, and more preferentially from 1 mm to 4 mm. The materials used are preferably chosen from metals, ceramics, glass, composites, and preferentially steel and ceramics.

The compressive stresses may also be introduced by a straightening process, with the aid of needles or other projectiles that acquire velocity in contact with a vibrating surface and impact the surface to be treated. These projectiles act as a network of small hammers striking the surface to be treated at high frequency and independently of one another. Surface compressive stresses are thus created. The difference in stresses between the surface and the core of the shield leads to modifications of the curvature thereof. The vibrating surface may in particular be vibrated by pneumatic means or by one or more linear Motors or by one or more sonotrodes,

The compressive stresses may also be introduced by a hammering technique, with the aid for example of a hammering gun as described in U.S. Pat. No. 6,343,495. In this technique, one or more projectiles, such as needles or hammers, preferably having a spherical head, are projected onto the surface to be treated by means of the vibration of a sonotrode. The impact of the projectiles on the surface to be treated generates the desired compressive stresses. The size of the head that impacts the surface to be treated ranges for example from 0.5 mm to 20 mm in diameter or width, and more preferentially from 1 to 6 mm; the length of the projectiles ranges for example from 2 to 50 mm. In order to produce the projectiles it is possible to use any material chosen from metals, ceramics, plastics, composites, and preferably steel.

The projectiles are confined between the vibrating surface that transmits energy to them and the surface to be treated. The amplitude of vibration of the vibrating surface ranges for example from 10 micrometers c/c to 200 micrometres c/c, and more preferentially from 30 to 80 micrometers c/c.

The frequency of the vibrating surface is for example between 15 kHz and 80 kHz, better still between 20 kHz and 40 kHz.

The ALMEN intensity of the treatment may range from F10N to F70C, preferentially F30N to F10C.

The technique used to introduce the compressive stresses may also be flap peening.

Flap peening uses a strip equipped at its ends with media encrusted in a matrix, as described in U.S. Pat. No. 3,638,464 A.

The strip is installed on an axle and rotated with. the aid of a pneumatic or electric wheel. The strip is applied to the part to be treated and the media strike this part.

The media have for example a size from 0.3 mm to 10 mm, preferentially from 1 mm to 4 mm. They may be made of metals, ceramics, glass or composites, preferentially made of steel or ceramic.

The rotational speed ranges for example from 0 to 10 000 rpm, preferentially between 1500 rpm and 6000 rpm. The angle of incidence of the media with respect to the normal to the surface to be treated may range from 0° to 90°. The ALMEN intensity of the treatment preferably ranges from F10N to F70C, more preferentially from F30N to F10C,

The compressive stresses may also be introduced by a laser shock peening technique, as described in U.S. Pat. No. 6,670,577 B2.

The shock waves are generated by an explosion due to very high power laser pulses, which make it possible to obtain pressures sufficient to exceed the elastic limit of the materials and a plastic deformation of the surface layers of the shield.

The implementation is performed with a laser beam directed onto the surface to be treated which creates a plasma.

The compressive stresses may also be introduced by roller burnishing or a similar process, in particular by the LPB (low plasticity burnishing) process which is a process similar to roller burnishing that uses a ball instead of a roller.

The surface layer of the part is then plastically deformed by rolling a roller or a bead under a high load over its surface.

It is also possible to apply the compressive stresses by autofrettage.

This amounts to applying to the shield a pressure greater than the operating pressure, in order to give rise to a heterogeneous plastic deformation across its thickness. During the releasing of the applied pressure, residual compressive stresses, known as autofrettage compressive stresses, appear. This pressure is applied over a short duration with the aid of a fluid (liquid, gas) or a conical tool, in a manner similar to rolling.

Compressive stresses may also be exerted with cavitation peening or water-jet peening techniques.

### Heat Treatment

The heat treatment may comprise a supply of heat in order to soften the binder used for fastening the shield to the core, which is typically an epoxy or cyanoacrylate adhesive.

The supply of heat may be carried out by conduction or convection and radiation or induction, or a combination of at least two of these heat transfer methods.

The temperatures reached may be between several degrees (20° C.) and several hundred degrees while remaining below the melting point or decomposition temperature of the core and of the skin, and usually between 20° and 200° C.

It is possible to use a device that blows hot air. As a variant, it is possible to place the part in a furnace, an oven or an apparatus comprising radiant panels or induction heating systems.

In the case of the production of cold, it is possible to use a refrigerator, freezer, deep-freezer, liquid nitrogen, or a vortex or vacuum effect tube to cool the part to be treated to a temperature preferably between −273° C. and 0° C.

### Core

Generally, the core may be composite with all types of materials, not limited to carbon fibers, for example glass fibers, aramid fibers and/or silicon carbide fibers amongst other possibilities. The core may be a monolithic or sandwich core. The processes for manufacturing these parts may be varied and cover all of the manufacturing processes based on thermosets and thermoplastics, including drape forming, weaving, RTM, LRI, stamping, thermoforming and thermocompression, amongst others.

The matrix of the core may be a polyester resin, epoxide resin, vinylester resin, phenolic resin or polyimide resin, this list not being limiting.

The core may also be metallic, for example made of aluminum or magnesium.

Generally, the core may comprise a matrix filled or reinforced in various ways.

### Binder

Any type of adhesive may be used, the binder not being limited to an epoxy or cyanoacrylate adhesive.

### Shield

The shield is preferably metallic, and may in particular be made of titanium or made of an alloy thereof. The shield may be made of ferromagnetic or non-ferromagnetic metallic material. The shield is for example made of a material chosen from titanium alloys, aluminum alloys, nickel-based alloys, copper-based alloys, magnesium alloys, Ta6V, Ti550, 7075, 2024, 2017, Inconel® (alloys comprising a large proportion of nickel and chromium and sometimes iron, amongst other compounds, these alloys having mechanical properties comparable to those of a stainless steel), Invar® (alloy of iron and nickel, having a very low expansion coefficient).

### Prior Machining Operation of the Shield

In order to facilitate the debonding of the shield, an upstream machining operation may be carried out in order to remove a frontal portion of the metal shield. This machining may be carried out by various material removal processes, including milling, waterjet cutting, grinding and sanding, amongst others. This operation is preferentially carried out before any other operation.

In FIG. 3, the boundary of the portion removed by machining has been indicated by a broken line. It is seen that this boundary concerns only the frontal portion 20 and a portion of the binder 14, the core 11 not being affected.

After machining, the shield 12 is in two separate pieces, that may be treated individually in order to separate them from the core.

### EXAMPLE

A turbomachine blade as represented in FIGS. 1 and 2 is treated which comprises a 3-D woven carbon fiber composite core and a titanium skin adhesively bonded to the core, forming a shield.

The skin is treated using a STRESSVOYAGER® shot-peening gun from the company SONATS equipped with an ER18-2 nozzle equipped with 3 mm diameter needles so as to obtain a stress level equivalent to an ALMEN intensity of F20A. The nozzle is moved along the blade, over the skin.

Next, the skin thus treated is exposed to the heat of a hot air gun delivering air at 350° C.

It is observed that the skin deforms owing to the compressive stresses previously introduced, and may be peeled off quite easily without damaging the core.

The invention is not limited to this example and applies to multiple parts comprising a core made of a first material to which a skin acting as structural reinforcement is adhesively bonded.

The expression “comprising a” should be understood as being synonymous with “comprising at least one”, unless otherwise specified.

1-29. (canceled)

30. A process for treating a composite part comprising a protective metal shield fastened to a core with the aid of a binder , with a view to separating the shield from the core, comprising
a) subjecting the metal shield to compressive stresses that tend to elongate it,
b) if necessary, heating the part or cooling it in order to soften or embrittle the binder.

31. The process as claimed in claim 30, step a) being carried out before step b).

32. The process as claimed in claim 30, step b) being carried out before step a).

33. The process as claimed in claim 30, steps a) and b) taking place simultaneously, step a) taking place in a furnace, an oven or in a refrigerated chamber, or by using a source of heat or cold coupled with a tool used to exert the compressive.

34. The process as claimed in claim 30, step a) being applied exclusively.

35. The process as claimed in claim 30, the introduction of the compressive stresses in step a) being carried out mechanically or by shock wave.

36. The process as claimed in claim 30, step a) being carried out so as to generate a plastic deformation of the metal shield, and induce residual stresses in said shield.

37. The process as claimed in claim 35, the introduction of the compressive stresses being carried out by conventional or ultrasonic shot peening, straightening, hammering, roller burnishing, including LPB, flap peening, laser shock peening, autofrettage, cavitation peening, water-jet peening and/or magnetic shock peening.

38. The process as claimed in claim 37 , the introduction of the compressive stresses being carried out by ultrasonic shot peening.

39. The process as claimed in either of claim 37, the shot peening being carried out with the aid of a captive projectile machine.

40. The process as claimed in claim 30, the ALMEN intensity of the treatment generating the compressive stresses being at least F10N to F70C, better still F30N to F10C.

41. The process as claimed in claim 30, the introduction of the compressive stresses being carried out locally with the aid of a machine moved over the part or a movement of the part relative to the machine.

42. The process as claimed in claim 30, the supply of heat or cold in step b) being carried out by conduction and/or convection and/or radiation and/or induction.

43. The process as claimed in claim 41, the supply of heat or cold being carried out locally with the aid of a machine moved over the part, or the part being moved under the application means of the process.

44. The process as claimed in claim 30, the supply of heat or cold being carried out so as to bring, locally at least, the binder to a temperature between −200° C. and 450° C.

45. The process as claimed claim 30, the shield being made of titanium or an alloy thereof.

46. The process as claimed in claim 30, the core comprising fibers and a matrix, of glass fibers, carbon fibers, aramid fibers or silicon carbide fibers, the matrix comprising a polyester, epoxide, vinylester, phenolic or polyamide resin.

47. The process as claimed in claims 30, the core being metallic made of steel, aluminum or magnesium, and alloys thereof.

48. The process as claimed in claim 30, the part being a blade or a vane of a turbomachine and the shield defining the leading edge of this blade or vane.

49. The process as claimed in claim 30, the shield being separated from the core, and after debonding from the core, replaced by a new metal shield adhesively bonded to the core.

50. The process as claimed in claim 30, the metal shield being machined before the introduction of the compressive stresses, in order to remove a frontal portion of the metal shield.
